(19) United States
(12) Patent Application Publication
(10) Pub. No.: US 2022/0003017 A1
(43) Pub. Date: Jan. 6, 2022

(54) RAPIDLY DEPLOYABLE SENSITIVE INFORMATION FACILITY

(71) Applicant: Rogue Industries, LLC, Fort Walton Beach, FL (US)

(72) Inventors: Christopher W. Rohe, Jacksonville, FL (US); David Fondacaro, Destin, FL (US)

(21) Appl. No.: 17/363,981

(22) Filed: Jun. 30, 2021

Related U.S. Application Data
(60) Provisional application No. 63/047,029, filed on Jul. 1, 2020.

(51) Int. Cl. E04H 15/02; H04L 29/06; E04H 15/34; E04H 15/58

(52) U.S. Cl. CPC E04H 15/02; E04H 15/58; E04H 15/34; H04L 63/102

(57) ABSTRACT

A rapidly deployable sensitive information facility may include a rapidly deployable a structure and preconstructed, pre-accredited panelized environment. The structure may be a tension fabric membrane shell having an extruded frame to support the tension fabric membrane. The structure may be configured to comply with one or more security accreditation requirements. The panelized environment may be positioned within the structure, and may comprise an access terminal in communication with one or more servers storing sensitive information. A user's access to the one or more servers may be conditioned on an authorization of the user with regard to the security accreditation requirement.

### CROSS REFERENCE TO RELATED APPLICATIONS

This application claims priority to US Provisional Patent Application Ser. No. 63/047,029, entitled “Rapidly Deployable Sensitive Information Facility” and filed Jul. 1, 2020, which is incorporated by reference herein in its entirety.

### BACKGROUND

### Field

The present disclosure relates generally to facilities for handling sensitive information, and specifically systems and methods for providing a rapidly deployable sensitive information facility for use therewith.

### Background

Various entities rely on sensitive information in order to operate and make decisions. Intelligence, military, law enforcement and other government agencies frequently create and handle sensitive information. Sensitive Compartmented Information (SCI) is an example of sensitive information relied upon by the United States military. The United States Department of Defense (DoD) generally describes SCI as classified information derived from intelligence sources, methods or analytical processes that must be handled within its formal control systems. Only accredited personnel may access, communicate, receive, store, use, process or discuss SCI, and they can only do so within an accredited Sensitive Compartmented Information Facility (SCIF). An area, room, or building can be accredited as a SCIF where SCI can be handled. SCIFs provide an important resource and support for a military unit's operations.

A facility must meet certain requirements in order to be accredited as a SCIF. Among other things, a facility's general design and strategy, configuration, materials, and construction process must comply with the applicable requirements. These requirements come from various sources, including DoD's Unified facilities Criteria (UFC), Sensitive Compartmented Information Facilities, planning, design and Construction, February 2013, revised October 2013. These requirements apply to SCIF facilities during construction, renovation and repair and can increase cost and construction time substantially. Additional delays can occur as a result of the ongoing SCIF accreditation process which must be completed before a facility can qualify as a SCIF.

DoD and other entities handling SCI and other sensitive information operate across a wide range of locations, where conditions and access to appropriate building materials can vary greatly. Construction, renovation and repair of a SCIF using traditional construction methods and materials can be time consuming and costly. Materials may be scarce or unavailable locally, requiring transportation of the needed items. These limitations can impede construction of new SCIFs and thus limit access to information and lead to reduced operational capability. Improved techniques for providing facilities for handling sensitive information.

### BRIEF DESCRIPTION OF THE DRAWINGS

FIG. 1 is a block diagram of a sensitive information network in accordance with some embodiments of the present disclosure.

FIG. 2 is a block diagram of a rapidly deployable sensitive information facility with a preconstructed panelized environment in accordance with some embodiments of the present disclosure.

FIG. 3 is a block diagram of a data center of a preconstructed panelized environment of a rapidly deployable sensitive information facility in accordance with some embodiments of the present disclosure.

FIG. 4 is a block diagram of a modular building structure of a rapidly deployable sensitive information facility in accordance with some embodiments of the present disclosure.

FIG. 5 depicts a three-dimensional perspective view of a rapidly deployable sensitive information facility in accordance with some embodiments of the present disclosure.

FIG. 6 depicts a three-dimensional perspective view of a preconstructed panelized environment of a rapidly deployable sensitive information facility in accordance with some embodiments of the present disclosure.

### DETAILED DESCRIPTION

### A. Definitions

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Numerical quantities given in this description are approximate unless stated otherwise, meaning that the term “about” or “approximately” can be inferred when not expressly stated.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only, and is not intended to be limiting. As used herein, the singular forms “a”, “an” and “the” are intended to include the plural forms as well, unless the context clearly indicates otherwise.

Spatially relative terms, such as “under”, “below”, “lower”, “over”, “upper” and the like, may be used herein for ease of description to describe one element or feature's relationship to another when the apparatus is right side up.

The terms “first”, “second”, and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

Terms such as “at least one of A and B” should be understood to mean “only A, only B, or both A and B.” The same construction should be applied to longer list (e.g., “at least one of A, B, and C”).

In some places reference is made to standard methods, such as but not limited to methods of measurement. It is to be understood that such standards are revised from time to time, and unless explicitly stated otherwise reference to such standard in this disclosure must be interpreted to refer to the most recent published standard as of the time of filing.

### B. Rapidly Deployable Sensitive Information Facility

A rapidly deployable sensitive information facility may include a rapidly deployable a structure and preconstructed, pre-accredited panelized environment. The structure may be a tension fabric membrane shell having an extruded frame to support the tension fabric membrane. The structure may be configured to comply with one or more security accreditation requirements. The panelized environment may be positioned within the structure and may comprise an access terminal in communication with one or more servers storing sensitive information. A user's access to the one or more servers may be conditioned on an authorization of the user with regard to the security accreditation requirement.

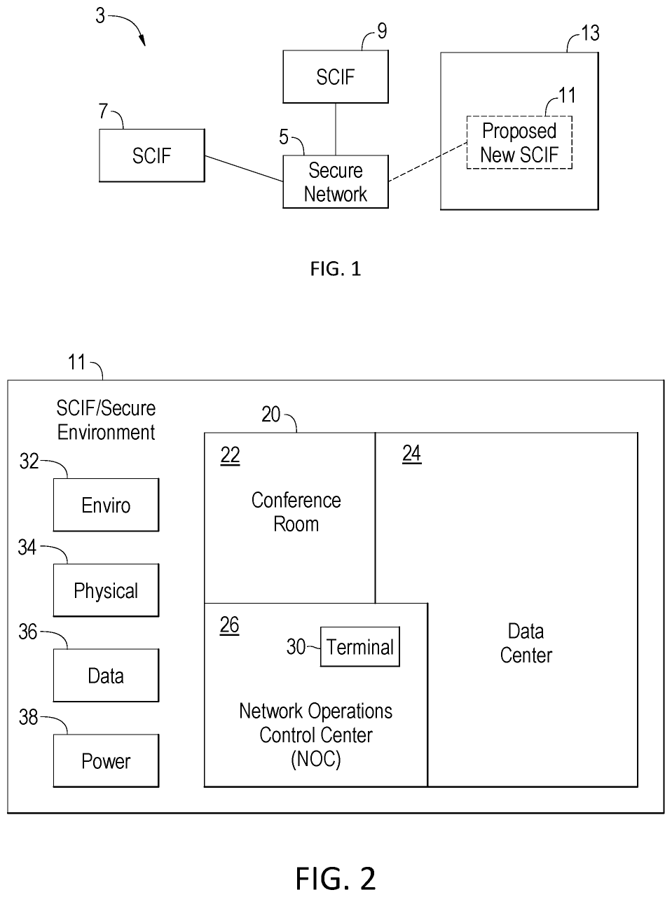

FIG. 1 is a block diagram of a sensitive information network 3 in accordance with some embodiments of the present disclosure. The network 3 comprises a secure network 5 that is in communication with a first SCIF 7 and second SCIF 9. Secure information may be communicated back and forth between the secure network 5 and SCIFs 7 and 9.

From time to time, a unit's mission may require additional SCIF space in order to meet demands for sensitive information in support of mission command, and a new SCIF 11 may be needed. Alternatively, a unit may deploy to a new geographic location or may encounter unexpected needs for additional space for handling classified information. In some instances, the demand for additional SCIFs can vary, and can range from one to many additional SCIF areas needed to provide needed command support.

In response, a location 13 for construction of a proposed new SCIF 11 may be identified. The identification may be based on a desired proximity to a unit's base location, area of operations or other aspects of operation of the proposed SCIF 11 and its support of unit command operations.

Note that requirements and specifications that apply in order for the new facility 11 to receive accreditation as a SCIF may depend on various aspects associated with the proposed new SCIF 11. For example, whether a proposed location 13 for the new SCIF 11 is within the United States may affect requirements applicable to features of the structure, such as minimum wall construction requirements (e.g., materials, intrusion detection, access control, duress features, etc.).

Exemplary standards, requirements and specifications applicable to various aspects of the SCIF 11, referred to herein as “security accreditation standards,” may be found in at least the following: Intelligence Community Directive (ICD) 705; National Counterintelligence and Security Center, “Technical Specifications for Construction and Management of Sensitive Compartmented Information Facilities” (version 1.4, Sep. 28, 2017); DoD Unified Facilities Criteria (UFC), “Sensitive Compartmented Information Facilities Planning, Design, and Construction” (1 Feb., 2013, rev. 1 Oct., 2013); Director of Central Intelligence Directive (DCID) 6/9, “Physical Security Standards for Sensitive Compartmented Information Facilities” (rev. 18 Nov., 2002); Joint Air Force-Army-Navy (JAFAN) 6/9, “Physical Security Standards for Special Access Program Facilities” (rev. 23 Mar., 2004); United States Army Regulation 380-27, “Control of Compromising Emanations”; CNSS 300, April 2004, National Policy on Control of Compromising Emanations; DoD Directive C-5200:19, May 16, 1995, Control of Compromising Emanations; DoD 5100.76-M, “Physical Security of Sensitive Conventional Arms, Ammunition and Explosives” (12 Aug., 2000); General Services Administration (GSA) FF-L-2740A (12 Jan., 1997); GSA FF-L-27406 (15 Jun., 2011); and Underwriters Laboratory (UL) 2050, “Standard for National Industrial Security Systems for the Protection of Classified Material” (5 Nov. 2010). One or more of the foregoing may be referred to herein as a “security accreditation requirement,” even though all or part of the subject matter of the respective documentation may relate to a requirement for accreditation other than “security” or other types requirements applicable to a new SCIF. Depending on the desired accreditation, various other specifications not specifically mentioned above may apply in some embodiments.

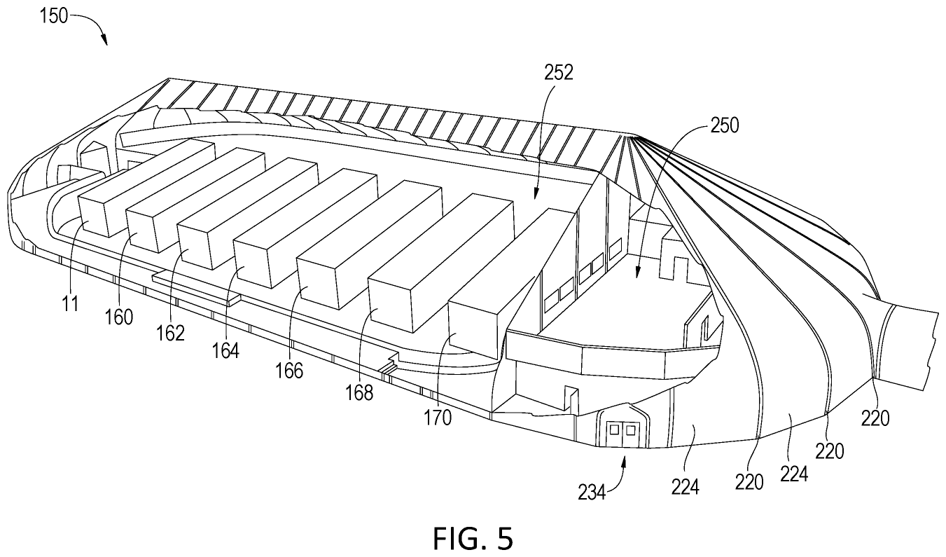

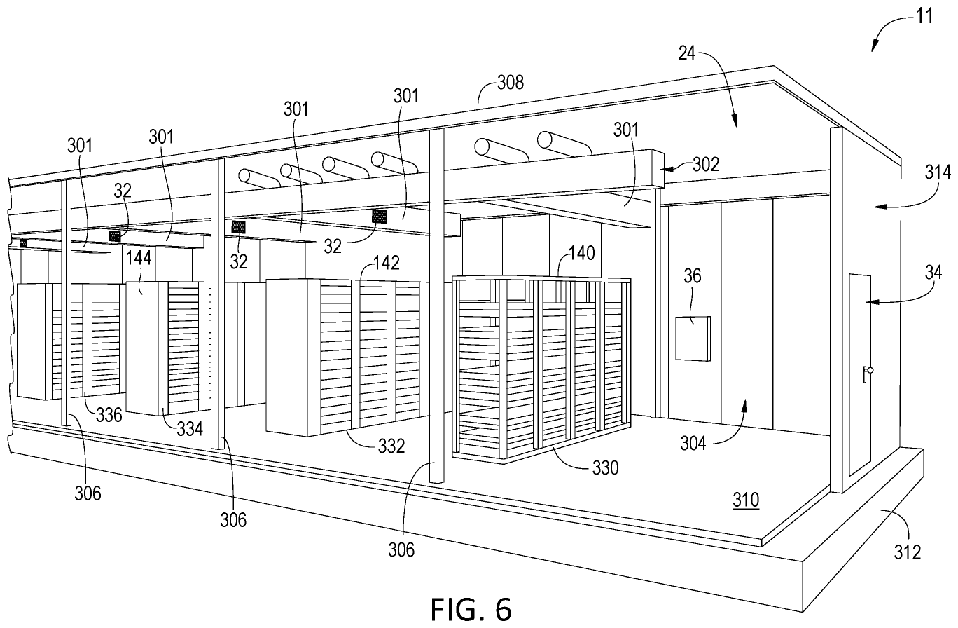

In some embodiments, the proposed new SCIF 11 may be configured as a portable, temporary facility, as described further below with regard to FIGS. 5-6. In some embodiments, once a location for the proposed new SCIF 11 has been selected, components of the proposed new SCIF 11 may be constructed and transported to the location 13 where they may be positioned, assembled, and configured for operation. When a change of location for the SCIF is desired, the SCIF 11 may be deconstructed or disassembled and transported for storage or for reassembly at a new location.

FIG. 2 is a block diagram of a rapidly deployable sensitive information facility with a preconstructed panelized environment in accordance with some embodiments of the present disclosure. The SCIF 11 may be configured to allow personnel to access and handle SCI in an accredited space, meeting one or more security accreditation standards, such as those described herein. The SCIF 11 includes a panelized environment 20, which may comprise one or more areas accredited for handling of SCI. In some embodiments, the panelized environment 20 can include a conference room 22, a data center 24, and network operations center (NOC) 26.

In the context of this document, the term “panelized” may refer to use of pre-constructed, prefabricated panels which may be assembled in one or more pre-determined arrangements or configurations to form all or a part of a structure or facility. In this regard, the panelized structure may be prepared for transportation as flattened panels, which may be removed, prepared and assembled upon arrival at a desired location. Thereafter the panelized structure may be disassembled, prepared for transportation, delivered to a new desired location, and reassembled.

Note that although the term “SCI” may be used to refer to sensitive information that may be handled in the facilities described herein, the systems and methods described herein may be implemented for handling other types of sensitive information and assembly and installation of facilities satisfying associated accreditation requirements and procedures in some embodiments.

SCIF 11 has a plurality of secure interfaces, including environmental interface 32, physical interface 34, data interface 36 and power interface 38. In some embodiments, each interface may be configured and fabricated to comply with at least one selected security accreditation standard.

Environmental interface 32 comprises one or more components to provide environmental regulation and control of the volume within the SCIF 11. Environmental interface 32 may include one or more various components of a heating, ventilation and cooling system, such as a heat exchanger or fan-operated forced-air unit. Although a single environmental interface 32 is shown in FIG. 2, in some embodiments, the SCIF 11 may comprise a plurality of interfaces 32, such as one or more ducts, pipes, vents, intake/exhaust ports, filters, fans, air circulators, valves or otherwise. In some embodiments, the environmental interface may be configured to achieve an airtight, hermetically sealed and sterile environment within the SCIF 11.

Physical access interface 34 may control physical access to the SCIF 11. Although a single physical access interface 34 is shown in FIG. 2, in some embodiments, the SCIF 11 may comprise a plurality of access interfaces 34, such as to facilitate access to the SCIF 11 from an external space, to facilitate access to conference room 22, data center 24, and NOC 26.

Physical access interface 34 may include one or more various components for controlling access, including one or more doors, locks, seals, hinges, frames, and thresholds. Components, materials and configuration of components of the physical access interface 34 may be selected based on requirements of one or more security accreditation standards. In some embodiments, the interface 34 may comprise one or more doors (e.g. wood, steel, etc.), including at least one perimeter door of the SCIF 11 and at least one interior door of the SCIF 11 (such as for access to panelized environment 20). By way of specific example, a door may be configured based on requirements for its use, such as inclusion of one or more door closing components for a door positioned on an exterior portion of the SCIF 11. As a further example, a primary entrance to the SCIF 11 may include various visitor control measures such as deadbolt doors, combination locks, etc. Further aspects and features of physical access interface 34 may be described further in one or more of applicable security accreditation standards.

One or more alarms (not specifically shown in FIG. 2) may be coupled to the physical access interface or oriented to monitor use of the physical interface access 34 and note information regarding its operation. Such information may include, by way of example only: information regarding information associated with one or more personnel accessing the SCIF 11 and panelized environment 20 via the interface 34 (e.g., identifying information, an associated authorization level, etc.); timestamps associated with access by one or more personnel, etc. Other information may be monitored for abnormalities by the alarm system and alerts may be issued in response to detection in some embodiments.

Data interface 36 may facilitate data communication between resources positioned within the SCIF 11 and external data sources (not specifically shown). The data interface 36 may comprise a network interface, and may include one or more network interface components that allow the resources operating within the SCIF 11, such as NOC 26 (e.g., terminal 30) and data center 24, to communicate with one or more computing devices, or external networks. The data interface 36 may facilitate communication between SCIF 11 resources and one or more networks or computing devices through various wireless technology (e.g., interfaces conforming with an applicable security accreditation standard and which communicate in accordance with 802.11 standards, such as WiFi, 3G, LTE, loT, Bluetooth, and/or the like) or through more traditional wired computer network communication, such as TCP/IP communication, ethernet, USB, or SPI. Such communication in any event may be governed by and in compliance with applicable security accreditation standards.

Power interface 38 may control power provided to resources of the SCIF 11. An appropriate power supply (not shown), which may include grid power, generator power, a back-up battery pack, etc., may provide line power to the SCIF 11 via power interface 38. The power interface 38 may include one or more or various combinations of logic, hardware and software for conditioning power and converts it to appropriate form (e.g., alternating current or direct current) for supplying power to the panelized environment 20 as well as the other components of the SCIF 11 described herein that require electrical power.

The panelized environment 20 may comprise various features and equipment for handling and communicating SCI. Although FIG. 2 shows panelized environment 20 as an area within an area identified as SCIF 11, in some embodiments, SCIF 11 and panelized environment may be coterminous, or SCIF 11 may be located within all or a portion of one or more areas of panelized environment 20.

Conference room 22 may be configured for review and discussion of SCI by authorized personnel, and may comprise one or more resources for reviewing and handling SCI (e.g., audiovisual equipment such as projection screens and visual projectors, etc.). Furniture, office supplies and other resources may be available within conference room 22, and each resource may be in compliance with one or more security accreditation standards applicable to the SCIF 11.

Network operations center (NOC) 26 may comprise various resources for managing and controlling operations of one or more networks (e.g., secure network 5) and the data center 24. The NOC 26 can include one or more user terminals 30, which may incorporate one or more computing devices configured to perform various desired operations, including processing, analyzing, communicating, receiving, retrieving, storing or otherwise handling SCI.

The computing device may be a processor controlled device, such as, by way of example, personal computers, workstations, servers, clients, mini-computers, main-frame computers, laptop computers, smart phones, tablets, a network of one or more individual computers, mobile computers, portable computers, handheld computers, palm top computers, set top boxes for a television, interactive televisions, interactive kiosks, personal digital assistants, interactive wireless devices, mobile browsers, or any combination thereof.

The computing device may be a uniprocessor or multiprocessor machine. Accordingly, a computing device may include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, discrete hardware circuits, and other suitable hardware configured to perform the various functionality described throughout this disclosure.

Additionally, the computing device may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies to transmit or store electronic content such as programs and data.

In particular, the one or more memories may store computer executable instructions that, when executed by the one or more processors, cause the one or more processors to perform operations including but not limited to processing, analyzing, communicating, receiving, retrieving, storing or otherwise handling SCI. The one or more processors may be operably associated with the one or more memories so that the computer executable instructions can be provided to the one or more processors for execution. For example, the one or more processors may be operably associated to the one or more memories through one or more buses. Furthermore, the computing device may possess or may be operably associated with input devices (e.g., a keyboard, a keypad, controller, a mouse, a microphone, a touch screen, a sensor) and output devices such as (e.g., a computer screen, printer, or a speaker).

The computing device may execute an appropriate operating system such as Linux, Unix, Microsoft® Windows® 95, Microsoft® Windows® 98, Microsoft® Windows® NT, Apple® MacOS®, IBM® OS/2®, and Palm® OS, and embedded operating systems such as Windows® CE or and the like. The computing device may advantageously be equipped with a network communication device such as a network interface card, a modem, or other network connection device suitable for connecting to one or more networks.

A computing device may advantageously contain control logic, or program logic, or other substrate configuration representing data and instructions, which cause the computing device to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and/or the like.

The control logic conventionally includes the manipulation of data bits by the processor and the maintenance of these bits within data structures resident in one or more of the memory storage devices. Such data structures impose a physical organization upon the collection of data bits stored within computer memory and represent specific electrical or magnetic elements. These symbolic representations are the means used by those skilled in the art to effectively convey teachings and discoveries to others skilled in the art.

The control logic is generally considered to be a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for computer operations, and that these terms are merely conventional labels applied to physical quantities that exist within and during operation of the computing device.

It should be understood that manipulations within the computing device are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computing device or computing devices.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with the teachings described herein. Similarly, it may prove advantageous to construct a specialized apparatus to perform the method steps described herein by way of dedicated computer with hard-wired logic or programs stored in nonvolatile memory, such as, by way of example, read-only memory (ROM).

In some embodiments, features of the computing device can be implemented primarily in hardware using, for example, hardware components such as application specific integrated circuits (ASICs) or field-programmable gated arrays (FPGAs). Implementation of the hardware circuitry so as to perform the functions described herein may be apparent to persons skilled in the relevant art(s). In yet another embodiment, features of the computing device can be implemented using a combination of both hardware and software.

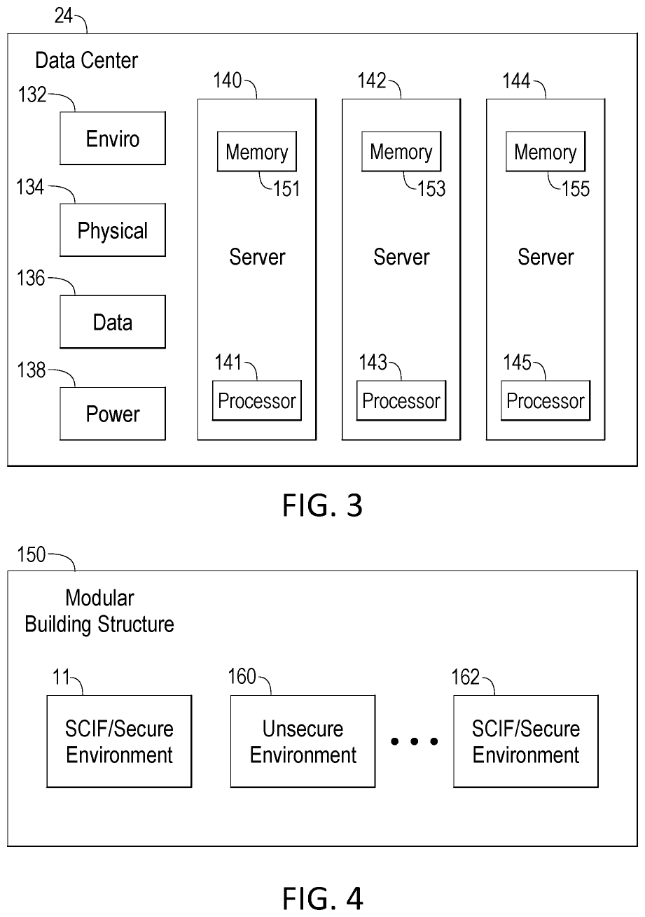

Data center area 24 may include one or more computing devices (e.g., servers) in communication with external data sources (e.g., secure network 5, SCIFs 7 and 9 in communication with the secure network 5 and associated computing devices). Data center area 24 is described in additional detail with regard to FIG. 3 below. In some embodiments, the data center area 24 may be configured for performing operations as a scalable data center, such as by performing communication and interoperation with one or more additional SCIFs and associated data centers. Although data center 24 is shown as having a particular area, dimensions and positioning within the panelized environment 20, in some embodiments the data center 24 may comprise different dimensions and occupy all or various portions of the panelized environment 20 and SCIF 11.

FIG. 3 is a block diagram of a data center within a preconstructed panelized environment of a rapidly deployable sensitive information facility in accordance with some embodiments of the present disclosure. The data center 24 may be configured and provided as a fully operational and scalable system for performing data center operations across a plurality of computing devices, such as one or more servers 140, 142, 144, one or more user terminals (not specifically shown) or various combinations thereof. The data center 24 may have its own interfaces which comply with applicable security accreditation standards, such as environmental interface 132, physical access interface 134, data interface 136 and power interface 138. The interfaces 132-138 may have features and functionality similar to the interfaces 32-38 of the SCIF 11 described above with regard to FIG. 2. The data center 24 may have other interfaces, or interfaces 132-138 may have various other features in some embodiments.

Servers 140-144 may be various types of computing devices for processing, analyzing, communicating, receiving, retrieving, storing or otherwise handling SCI. The servers 140-144 may be configured in various ways, including similarly to one another, in some embodiments. For illustrative purposes and efficiency of discussion, exemplary server 140 may include one or more general-purpose processors 141, but one or more additional servers 140-144 may include all, part or various combinations of the functionality ascribed to the server 140. In a specific embodiment, a memory 151 (e.g., such as non-volatile RAM and/or ROM) also forms part of a CPU (not specifically shown). When acting under the control of appropriate software or firmware, a CPU may be responsible for implementing specific functions associated with the functions of a desired data center 24 device such as server 140 or servers 142-144. The CPU preferably accomplishes all these functions under the control of control logic, which may include software including an operating system, and any appropriate applications software. Memory 151 may be provided to store computer executable instruction, which when executed by the processors allow the processors 141 to implement the herein described functionality. The memory 151 may include volatile memory (e.g., RAM), non-volatile memory (e.g., disk memory, FLASH memory, EPROMs, etc.), unalterable memory, and/or other types of memory. According to different embodiments, one or more memories or memory modules (e.g., memory blocks) may be configured or designed to store data, program instructions for the functional operations of the data center 24, as well as processing, communication, handling, storage of SCI and/or other information. The program instructions may control the operation of an operating system and/or one or more applications, for example. The memory or memories 151 may also be configured to store data structures, metadata, identifier information/images, and/or information/data relating to other features/functions described herein. Additional suitable device driver(s) may also be provided, as may be one or more display(s) (not specifically shown).

Note that servers 140-144 may have various components to achieve functionality needed to carry out operations of the data center 24. As a mere example, server 140 may include server component(s) which provide various functions and operations relating to communications activities and communications. Similarly, server 142 may include network server component(s) configured to provide various functions and operations relating to network server activities and communications. Server 144 may include user accreditation and security information and components in order to manage various aspects of user accreditation, access permissions and related information. Other servers may be present in some embodiments and may include various components required to achieve the functionality described herein.

Note also that servers 140-144 and other resources of the data center 24 may be configured for performing edge computing. A SCIF 11 may comprise one or more nodes (not specifically shown) of an edge computing network (such as secure network 5). In some embodiments, one or more servers 140-144 within the data center 24 of SCIF 11 may be configured to implemented one or more nodes of an edge computing network hierarchy. Various other servers positioned in SCIFs of the system 3 may be configured to perform edge computing techniques to achieve the functionality described herein.

As an example, in some embodiments, server 140 may be configured to receive information communicated from one or more other nodes of an edge computing network. The server 140 may process the information (e.g., using instructions or rules stored as server logic in memory 151 and executed by processor 141) it receives. In some embodiments, the server 140 may execute server logic to make determinations about the information it receives, including whether security accreditation standards are implicated based on source/address information, metadata, contextual information, or content of the information received. Based on these determinations the server 140 may determine that it may or may not communicate the information to other nodes (e.g., one or more peer nodes, or nodes that are lower or higher in the edge computing hierarchy) or allow a user of the server 140 to access and handle the information. If the information can be communicated or accessed, the server 140 may provide the information for transmission or access and handling. If not, the server 140 may store the information and restrict access or otherwise treat the information in accordance with one or more of the security accreditation standards applicable to the information and the server 140.

As with other components of the rapidly deployable information facility (SCIF 11) the data center 24 may be configured to be assembled, disassembled, moved and reassembled as desired to facilitate mission objectives and operations. For example, a plurality of interfaces, such as data interfaces (e.g., networking etc.) and physical interfaces of the data center 24 may allow it to be used in connection with other data centers. In this regard, the data center 24 can be seen as an “appliance” for providing computing capabilities for new or existing SCIFs.

In some embodiments, the data center 24 may have a configuration allowing for a user to select and modify capabilities of the data center 24 in advance to achieve a desired configuration and compliance with one or more security accreditation standards. In some embodiments, a user may determine characteristics of the data center 24 during an initial design and pre-configuration process for the data center 24. As an illustration, a user may select a desired modification and modify a number of racks, power rating for each server rack, features for mechanical and electrical redundancy (N1, N2, 2N), etc. Such features may be selected with regard to one or more desired or applicable security accreditation standards.

FIG. 4 is a block diagram of a modular building structure of a rapidly deployable sensitive information facility in accordance with some embodiments of the present disclosure. In some embodiments, one or more preconstructed, pre-accredited SCIF facilities may be positioned within another larger, modular structure. These SCIF facilities may operate within the same structure 150 as other preconstructed facilities for performing various operations for which accreditation is not required. However, in some embodiments, the one or more SCIF facilities may be essentially indistinguishable from the other preconstructed facilities contained within the modular structure. In this regard, the rapidly-deployable sensitive information facility may be configured to allow operation of one or more SCIFs as described hereinabove, in addition to one or more facilities performing non-accredited operations.

In the embodiment of FIG. 4, the modular building structure 150 of has a plurality of preconstructed environments 11, 160, and 162 positioned within the structure 150. SCIF 11 may be configured as described above with reference to FIGS. 1-3. SCIF 162 may be configured similarly to SCIF 11. Either of SCIF 162 or SCIF 11 may be configured to comply with one or more security accreditation requirements, which need not be the same for both SCIF 11 and SCIF 162 in some embodiments. Although a particular arrangement of environments within the modular building structure 150 is shown in FIG. 4, it will be appreciated that in some embodiments, arrangement and number of facilities within the structure 150 may be varied as desired to achieve a desired operational capability for the facility 150 and to achieve desired support for mission operations.

Facility 160 may be an unsecured environment that may be located within modular building structure 150 and may have various features for achieving essentially any desired, permissible purpose to support unit operations. Facility may have features similar or identical to those ascribed to SCIF 11 and may be ready for accreditation even though the facility 160 may not be pre-accredited. In some embodiments, the facility 160 may be configured for other uses, such as to provide storage, housing, etc. Other uses for the facility 160 are possible in some embodiments.

In some embodiments, the facility 160 may be preconstructed for use as medical treatment facility. The facility 160 may include one or more of the various interfaces 32-38 and 132-138 ascribed to the SCIF 11 and its data center 24, although other interfaces are possible to achieve the functionality described herein. When implemented as a medical facility, the facility 160 may be configured as an airtight, hermetically sealed and sterile, with photo-catalytic interior surfaces to eradicate airborne contaminants and pathogens. Rather than a data center 24, the facility 160 may include a medical ward with computing devices configured to monitor diagnostic information for patients and process and communicate such information with one or more other sources (e.g., via a network in communication with the facility 160). Additional computing devices (not specifically shown) may facilitate communications with various other sources, and may be configured to facilitate treatment operations such as telemedicine and remote video conferencing. Additional details for providing a medical facility are described in U.S. Provisional Patent Application Ser. No. 63/047,029, entitled “Rapidly Deployable Sensitive Information Facility” and filed Jul. 1, 2020, which is hereby incorporated by reference herein in its entirety.

FIG. 5 depicts a three-dimensional perspective view of a rapidly deployable sensitive information facility in accordance with some embodiments of the present disclosure. The facility 150 includes a vestibule area 250 and data center area 252, but in some embodiments other locations, sizes and types of areas are possible. The facility 150 includes a plurality of preconstructed, panelized facilities configured to perform various desired operations. In the embodiment of FIG. 5, facilities 11 and 160, 162, 164, 166, 168 and 170 have been assembled within the structure 150. As noted above, one or more of the facilities 11 and 160-170 may be accredited as a SCIF; one or more of the facilities 11 and 160-170 may be used for one or more other purposes. In some embodiments, all of the facilities 11 and 160-170 may be accredited for operation as SCIFs. In this regard, the structure 150 also may be capable of accreditation as a SCIF under one or more applicable security accreditation standards.

The structure 150 may have one or more features similar to those features found in embodiments of structures produced by Sprung Instant Structures, Ltd., and described in the following U.S. Patents and U.S. Published Patent Applications, each of which hereby is incorporated by reference herein in its entirety: U.S. Pat. No. 9,777,505, entitled “Door System For Movable Structures” and filed Oct. 15, 2015; U.S. Pat. No. 7,849,639, entitled “Stressed Membrane Structure” and filed Nov. 2, 2004; U.S. Publ. No. US2003/0019166, entitled “Door Arrangement for Tensioned Membrane Structure” and filed Jul. 30, 2002; U.S. Pat. No. 5,283,993, entitled “Hydraulically-Operated Scissor Opening for Stressed Membrane Structure” and filed Jun. 3, 1991; U.S. Pat. No. 4,773,191, entitled “Light and Climate Control System for Pre-Stressed Fabric Structures” and filed Jan. 20, 1987; and U.S. Pat. No. 3,780,477, entitled “Demountable Building” and filed Jul. 28, 1971.

In some embodiments, the structure 150 may be a demountable tension membrane structure as shown in FIG. 5. The structure 150 of FIG. 5 has features similar to the structures described and shown in the references mentioned above, in particular, U.S. Pat. No. 7,849,639 to Sprung (herein “Sprung”). The structure 150 has membranes 224 (item 24 in Sprung) secured by their edges between pairs of arc frames 220 (item 20 in Sprung). The structure 150 also may include some or all of the components associated with the structures described in Sprung and the other references incorporated by reference herein (e.g., including but not limited to hardware, ropes, pulleys, rollers, brackets, connectors, spreaders, I-beams, flanges, bars, doors, nuts, bolts, assemblies, ventilators, etc.) as well as modifications and variants to such components.

In addition, the structure 150 has a door 234 (e.g., physical access interface) which may be configured to comply with one or more applicable security accreditation standards. The structure 150 has additional doors, interfaces (e.g., interfaces 32-38, 132-138), and other features needed to provide needed functionality and compliance with one or more applicable security accreditation standards.

Note that the structure 150 may be configured to comply with applicable building codes, such as ASTM, International Building Code, local municipal and state codes and other applicable building standards in addition to the applicable security accreditation standards.

Further, the structure may be fabricated, transported, assembled, disassembled and reassembled according to one or more of the techniques set forth in the references listed above and incorporated by reference herein.

Dimensions of the structure 150 may vary based on various criteria, such as size limitations imposed by location selection, proximity to other structures, or otherwise. In order to accommodate the facilities 11, 160-170, the structure 150 may have dimensions selected with reference to dimensions of the particular facilities which will be used in conjunction with the structure 150 as well as applicable security accreditation standards.

Note that, although embodiments in which the structure 150 is a tension membrane shell structure are discussed herein, in some embodiments, other types of structures may be used to achieve the functionality described herein. For example, preconstructed, pre-accredited assemblable/dis-assemblable/re-assemblable structures may be used as structure 150 in some embodiments where cost, material availability and transportation may be issues, among other concerns. Additional details for providing a structure 150 are described in U.S. Provisional Patent Application Ser. No. 63/047,029, entitled “Rapidly Deployable Sensitive Information Facility” and filed Jul. 1, 2020, which is hereby incorporated by reference herein in its entirety.

FIG. 6 depicts a three-dimensional perspective view of a preconstructed panelized environment of a rapidly deployable sensitive information facility in accordance with some embodiments of the present disclosure. FIG. 6 shows a SCIF 11 with a data center 24 which is configured similar to the data center of FIG. 2-3. The data center 24 has servers 140-144 which are mounted in various locations on racks 330, 332, 334 and 336. Note that the servers 140-144 may be configured similarly to the servers of FIG. 3 and may be configured to achieve similar functionality. Although not specifically shown in FIG. 6, the SCIF 11 may also have a conference room 22 and NOC 26. The SCIF 11 of FIG. 6 is in a configuration that is compliant with one or more security accreditation standards.

The SCIF 11 has a plurality of panelized walls 304, 314 as well as a panelized ceiling 308 and floor 310. Two walls 304 and 314 are visible in FIG. 6 because of the cutaway perspective view, but in some embodiments, it will be appreciated that the SCIF 11 is essentially enclosed, self-contained, and airtight. The walls also include supports 306 for supporting roof 308 and elements of the SCIF 11 suspended from an underside of the roof 308. In some embodiments, the roof 308, walls 304, 314 can include various components and finishings to achieve compliance with one or more security accreditation standards.

The walls 304, 314 and roof 308 can include components for facilitating the operations of the SCIF 11, such as plumbing or electrical conduit, insulation, noise reduction features, etc. A hard-wired electrical box 36 (e.g. data interface 36) is positioned on wall 304 to facilitate control of electrical properties of the SCIF 11 and to permit wired access to the resources of the SCIF 11 and data center 24.

A foundation 312 supports the floor 310 and may be various types of foundations such as a slab or one or more foundation members arrangeable in a desired configuration. Foundation 312 can be various materials, such as concrete, wood, a metal, or various composite materials.

The SCIF 11 includes a door 34 (e.g., physical access interface) configured to control access to the data center 24 in an accredited manner. The data center 24 includes a plurality of vents 32 positioned on a plurality of ducts 301 (e.g., environmental interfaces) configured to provide ventilation and condition the air inside the data center 24. The ducts 301 are supported by a support beam 302 which alternatively can be one or more brackets coupled to the ducts 301 to provide support. Other components are possible within the data center 24 in some embodiments, and the foregoing should not be perceived as an intent to limit any aspect of the features of the SCIF 11.

Example structural capabilities for the SCIF 11 may include, for example: a minimum roof load strength of approximately 40 Ib./ft.²; minimum wind load strength of approximately 2 hr. ×100 mph sustained; minimum bending stress strength of approximately 13,000 psi; seismic rating of at least site Class D; minimum STC of 40; minimum 85% high reflectance of interior finishes; minimum 90 minutes fire/thermal rating for walls, ceilings, doors penetrations (ASTM E119); minimum 90 minutes fire/thermal rating for doors (NFPA 252); minimum “R” value of r22; ASTM hydrodynamic and permeability requirements such as size dependent airtight time requirements (NFPA 2001); encapsulation standards (ASTM E1795-97); mildew resistance (ASTM D3273/3274); permeability (ASTM D1653); weathering (ASTM G53/B117—Federal TT-c-555B); humidity (ASTM D4585); Hose Stream (ASTM E119); Survivability and Lethality Directorate for Structural Integrity: FEBR/Blast/wind/Fire/Thermal (DoD); SCIF STC and RF attenuation (HEMP/TEMPEST); and ICD/ICS 705 Compliance.

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

The foregoing description illustrates and describes the processes, machines, manufactures, compositions of matter, and other teachings of the present disclosure. Additionally, the disclosure shows and describes only certain embodiments of the processes, machines, manufactures, compositions of matter, and other teachings disclosed, but, as mentioned above, it is to be understood that the teachings of the present disclosure are capable of use in various other combinations, modifications, and environments and is capable of changes or modifications within the scope of the teachings as expressed herein, commensurate with the skill and/or knowledge of a person having ordinary skill in the relevant art. The embodiments described hereinabove are further intended to explain certain best modes known of practicing the processes, machines, manufactures, compositions of matter, and other teachings of the present disclosure and to enable others skilled in the art to utilize the teachings of the present disclosure in such, or other, embodiments and with the various modifications required by the particular applications or uses. Accordingly, the processes, machines, manufactures, compositions of matter, and other teachings of the present disclosure are not intended to limit the exact embodiments and examples disclosed herein. Any section headings herein are provided only for consistency with the suggestions of 37 C.F.R. § 1.77 or otherwise to provide organizational queues. These headings shall not limit or characterize the invention(s) set forth herein.

I claim:

1. A method for providing a rapidly deployable sensitive information facility, comprising:
(a) providing a structure comprising a tension fabric membrane shell and an extruded frame to support the tension fabric membrane shell, wherein a first characteristic of the structure is selected based at least on a security accreditation requirement; and
(b) providing a panelized environment within the structure, wherein the panelized environment comprises an access terminal in communication with one or more servers, wherein a user's access to the one or more servers is conditioned on an authorization of the user with regard to the security accreditation requirement.

2. The method of claim 1, wherein the access terminal is located within a portion of the panelized environment meeting a qualification for a Sensitive Compartmented Information Facility (SCIF) under the security accreditation requirement.

3. The method of claim 2, wherein the panelized environment further comprises an environment comprising a second access terminal in communication with another one or more servers, wherein the user's access to the another one or more servers is not conditioned on an authorization of the user with regard to the security accreditation requirement.

4. The method of claim 3, wherein the panelized environment further comprises a second portion of the panelized environment meeting the qualification for a Sensitive Compartmented Information Facility (SCIF) under the security accreditation requirement.
